(19) United States
(12) Patent Application Publication
(10) Pub. No.: US 2016/0352804 A1
(43) Pub. Date: Dec. 1, 2016

(54) DECREASING WEBSITE LOAD TIMES TO INCREASE E-COMMERCE CONVERSION

(71) Applicant: BLUE TRIANGLE TECHNOLOGIES, INC., Mechanicsville, VA (US)

(72) Inventors: DONALD EDWARD FOSS, MECHANICSVILLE, VA (US); TIMOTHY GARY GRANT, MECHANICSVILLE, VA (US)

(21) Appl. No.: 15/168,940

(22) Filed: May 31, 2016

Related U.S. Application Data
(60) Provisional application No. 62/167,870, filed on May 28, 2015.

(51) Int. Cl. H04L 29/08

(52) U.S. Cl. CPC H04L 67/02; H04L 67/34

(57) ABSTRACT

A computer-implemented method and computer program product for serving a webpage comprises determining, by a computer, an actual load time of each of one or more webpages requested by a user; comparing, by the computer, the actual load time for each webpage to a predetermined maximum desired load time specific to each webpage; and if the actual load time for any of the one or more webpages is above the respective predetermined maximum desired load time, serving, by the computer, a lighter version of a subsequent webpage requested by the user.

### CROSS-REFERENCE TO RELATED APPLICATIONS

This application claims priority to pending U.S. Provisional Application Ser. No. 62/167,870, filed May 28, 2015, the contents of which are incorporated herein by reference in its entirety.

### FIELD OF THE INVENTION

This invention relates to website display configuration.

### BACKGROUND

Goods and services are purchased online at ever-increasing rates. E-commerce merchants strive to provide content-rich e-commerce websites which provide helpful information to potential purchasers, are visually pleasing, and hopefully entice potential purchasers to complete a purchase.

Potential purchasers value speed, and desire to complete e-commerce transactions quickly with minimal delay. Data has shown that e-commerce conversions (i.e., the percentage of e-commerce website visitors who complete a purchase during a particular visit) decrease if navigation through an e-commerce website is slow or if a transaction is delayed. E-commerce merchants desire, of course, to maximize conversions of visitors to their websites.

### BRIEF SUMMARY

In one embodiment of the invention, a computer-implemented method for serving a webpage comprises determining, by a computer, an actual load time of each of one or more webpages requested by a user; comparing, by the computer, the actual load time for each webpage to a predetermined maximum desired load time specific to each webpage; and if the actual load time for any of the one or more webpages is above the respective predetermined maximum desired load time, serving, by the computer, a lighter version of a subsequent webpage requested by the user.

Serving, by the computer, a lighter version of a subsequent webpage requested by the user may comprise serving, by the computer, a lighter version of all subsequent webpages requested by the user during a current browsing session.

The predetermined maximum desired load time specific to each webpage may be based on data for a plurality of users of actual historical load times for each webpage correlated to completed purchases of goods or services during a same browsing session.

In another embodiment of the invention, a computer-implemented method for serving a webpage comprises determining, by the computer, an actual load time of a first webpage requested by a user; comparing, by the computer, the actual load time for the first webpage to a predetermined maximum desired load time specific to the first webpage; and if the actual load time for the first webpage is above the predetermined maximum desired load time, serving, by the computer, a lighter version of a subsequent webpage requested by the user.

In addition to the methods, as described above, other aspects of the present invention are directed to corresponding systems and computer program products for serving a webpage.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 is a high level flowchart of a method of serving webpages, in accordance with embodiments of the present invention.

FIG. 2 is a schematic block diagram of a computer network in which embodiments of the present invention may operate; and

FIG. 3 is a schematic block diagram of a computer in the network of FIG. 2.

### DETAILED DESCRIPTION

Embodiments of the invention enable an e-commerce merchant to identify website visitors who are in danger of not completing a transaction because of slow loading of the merchant's website and to improve website loading speed for such a visitor by serving a different, lighter (and therefore faster loading) version of subsequently requested webpages. This process is referred to herein as “conversion boost.”

Embodiments of the invention provide a JavaScript tag that measures various performance metrics about a webpage load as well as purchase and branding information. For e-commerce sites, embodiments of the invention correlate the load speed for each page of an e-commerce site to the decision to buy as well as the amount that a visitor will purchase. Embodiments of the invention measure these details on behalf of e-commerce merchants on each merchant's respective websites. The e-commerce merchants add a JavaScript source include to each page of their site allowing the necessary code to load on each customer visit. The btt.js JavaScript source include is added to a global footer or tag manager. The btt.js JavaScript source include may be:
<script async=‘true’ type=“text/JavaScript” src=“//demo.btttag.com/BTT/btt.js”></script>

When the JavaScript tag loads and activates it sets an event listener and collects the “Navigation Timing” timings for each browser that supports the Navigation Timing Spec (see the W3C Navigation Timings Web Page at: http://www.w3.org/TR/navigation-timing-2/ (the contents of which are incorporated herein in their entirety)). The JavaScript tag also collects the Resource Timings for a subset of pages for supported browser types on the site (see Resource Timings Details at: http://www.w3.org/TR/resource-timing/ (the contents of which are incorporated herein in their entirety)).

In addition to performance metrics, the tag may also collect web analytics data about the page, such as: page type, page name, page URL, browse type, device type, end user's IP address, derived geolocation of the visitor, the amount in user's shopping cart, and/or the amount that the user spent during that particular visit. The tag then packages up this data and sends it to be analyzed with a transparent image request or cross domain post with the data in the payload of the request.

Performance data may be sent to be analyzed in two forms: using HTTP protocols of the same or similar version and security level either as parameters to an image pixel request, or in the body of an application request.

Embodiments of the invention then process the data to correlate, at the macroscopic level, the effect that page speeds for each page in the sales funnel have on the decision to buy, also known as the conversion rate. Embodiments of the invention also measure the effect the page speeds have on bounce rate, number of pages per visit, revenue per visitor, average order value (AOV), and many other derived analytics. A conversion rate curve is determined, which plots the load time for a specific page (typically for a specific day of the week) against the conversion rate.

In one example of the correlation between page load speeds and conversion, data from a specific webpage of a specific website was analyzed, and it was determined that: (1) if the webpage loaded in 2.9 seconds or faster on average the conversion rate was about 2.4% or greater; (2) if the webpage loaded in between 2.9 and 4 seconds on average the conversion rate was between about 2.4% and 1.6%; and (3) if the webpage loaded in 5.1 seconds or slower on average the conversion rate was about 1.1% or lower.

The data may be classified in groups or ranges of load times and conversion rates, and referred to (e.g.,) as green (desirable), yellow (caution), and red (undesirable). The specific ranges of the classifications may be determined in conjunction with the e-commerce merchant and based on the merchant's conversion rate targets. This data is typically broken down by the day of the week, and may be limited to a subset of the webpages on a particular e-commerce website.

The JavaScript tag of embodiments of the invention includes conversion rate curve details for select pages of the merchant's site (typically specific to each day of the week) such that the tag can intelligently identify if a visitor had an experience which makes abandoning without purchasing highly likely.

The JavaScript tag is preferably regenerated periodically with the data describing the conversion rate curves for the current day of the week using previously collected data on the particular website.

The data analysis portion of embodiments of the invention described above is typically performed by a data analysis provider, which may be providing such analysis to a large number of e-commerce merchants. The data analysis provider embeds the conversion rate curve details into the JavaScript tag, and provides the JavaScript tag (and frequent updates thereto) to the e-commerce merchant for incorporation into the e-commerce website as described above.

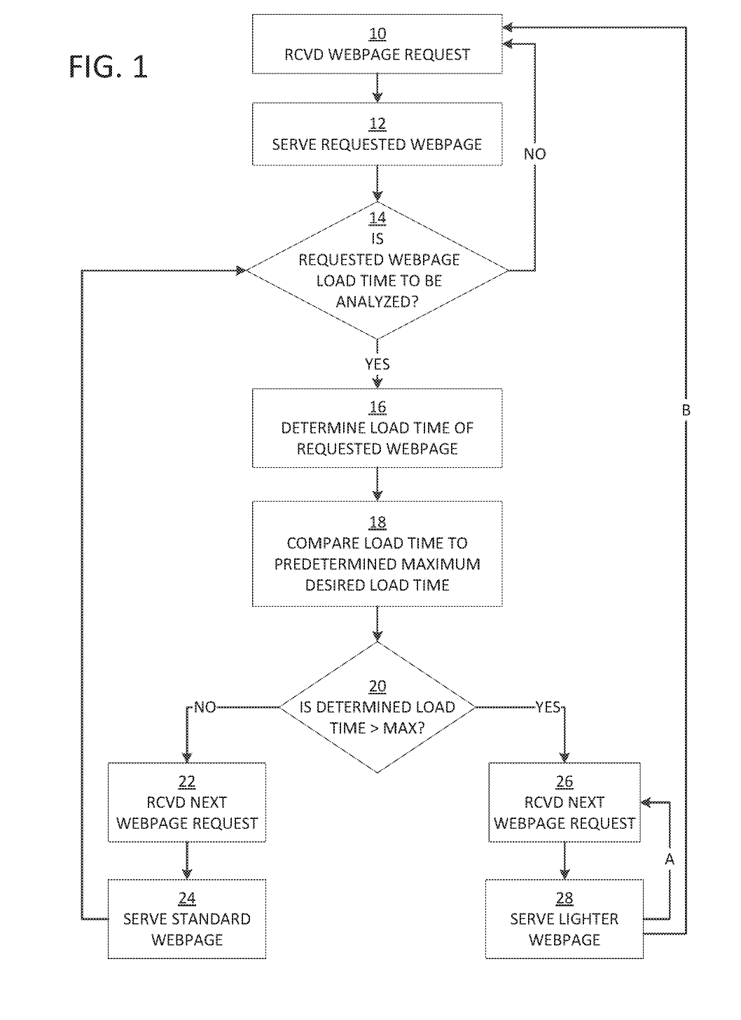

Referring now to FIG. 1, a high level flowchart illustrates a method of serving a webpage, in accordance with embodiments of the present invention. The webpage request is received from a user (i.e., a potential customer) 10, and the requested webpage is served by the e-commerce site to the user 12. The embedded JavaScript tag code executes on the user's computer. As typically only a subset of webpages in a particular website are subject to the conversion boost process of embodiments of the invention, it is determined if the served webpage is one of the webpages whose load time should be analyzed 14. If not, the website continues to receive requests and serve requested webpages as usual.

If the served webpage is one of the webpages whose load time should be analyzed, the load time of the just-served webpage to the user is determined 16. The determined load time of the just-served webpage is compared to the predetermined maximum desired load time (which, as discussed above, is based on a targeted conversion rate or range of conversion rates) 18. This comparison may involve comparing the current page load time with the conversion rate curve for the respective page and determining if the page load time falls into the red zone or above a specified amount of time. If the determined load time is not greater than the predetermining maximum (i.e., not in the red zone) 20, then the website continues to receive requests 22 and serve requested webpages 24 as usual. Those subsequently served standard webpages are also subjected to the process detailed in blocks 14-20 of FIG. 1.

If the determined load time is greater than the predetermining maximum (i.e., in the red zone) 20, then upon receipt of the next webpage request from the user 26 a lighter version of the requested webpage is served to the user 28.

Strategies for serving lighter pages include, but are not limited to, any one or more of optimizing graphics, combining JavaScript files, showing fewer products on the page, reducing third party content options, reducing or removing retargeting or shopping cart add-on features, reducing or removing extra branding options, reducing or removing added media and videos, and/or reducing or removing real-time product customization tools.

If the determined load time is greater than the predetermining maximum, the user may continue to be served lighter pages in response to all subsequent requests during that particular visit (indicated by line A in FIG. 1). Alternatively, if the determined load time is greater than the predetermining maximum, a lighter version is served for only the very next webpage request and the process begins again (indicated by line B in FIG. 1).

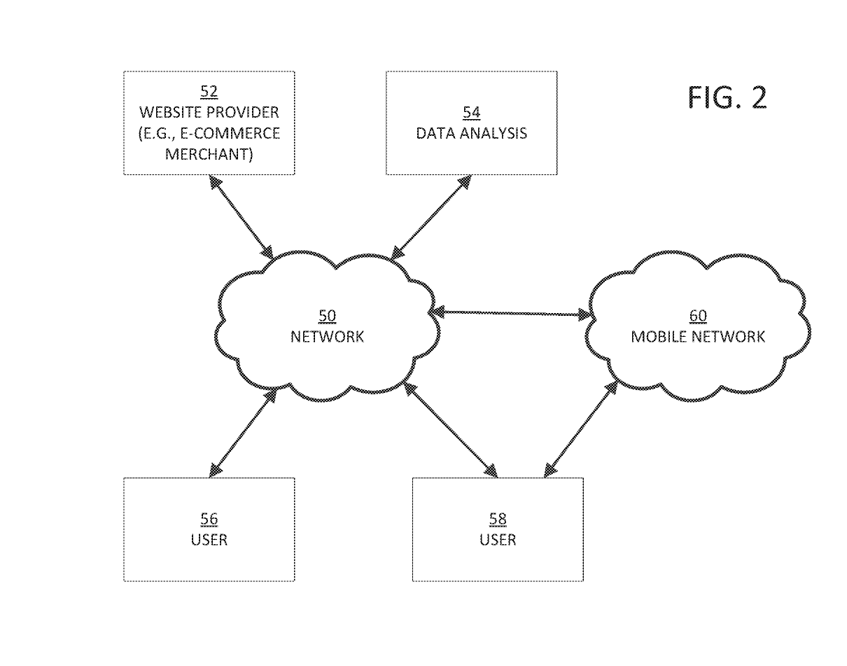

FIG. 2 is a schematic block diagram of a system in which embodiments of the present invention may operate. In the system of FIG. 2, block 52 represents a server(s) of an e-commerce merchant which receives webpage requests from users 56, 58 and serves the requested webpages to the users (either standard webpages or lighter webpages, as described above). Blocks 56, 58 represent, for example, computers or mobile computing devices of users (i.e., potential customers). Block 54 represents a server(s) upon which the correlation between load times and conversions may be determined, as described above. Server(s) 54 is typically, but not necessarily, provided by a third party data analysis provider. Communications among the devices involved in the process may occur over network 50. Communications may also occur over mobile network 60 for devices that are so equipped.

The devices in FIG. 2 provide processing, storage, and input/output devices executing application programs and the like. Communications network 50 can be part of the Internet, a worldwide collection of computers, networks, and gateways that currently use the TCP/IP suite of protocols to communicate with one another. The Internet provides a backbone of high-speed data communication lines between major nodes or host computers, comprising thousands of commercial, government, educational, and other computer networks, that route data and messages. However, the devices in FIG. 2 may be linked over any suitable communication network. Mobile network 60 may be any suitable mobile communications/data architecture (such as a mobile telecommunications network adhering to the International Mobile Telecommunications-2000 (also termed 3G) or IMT-Advanced (also termed 4G) standards), in which a mobile telecommunications device communicates.

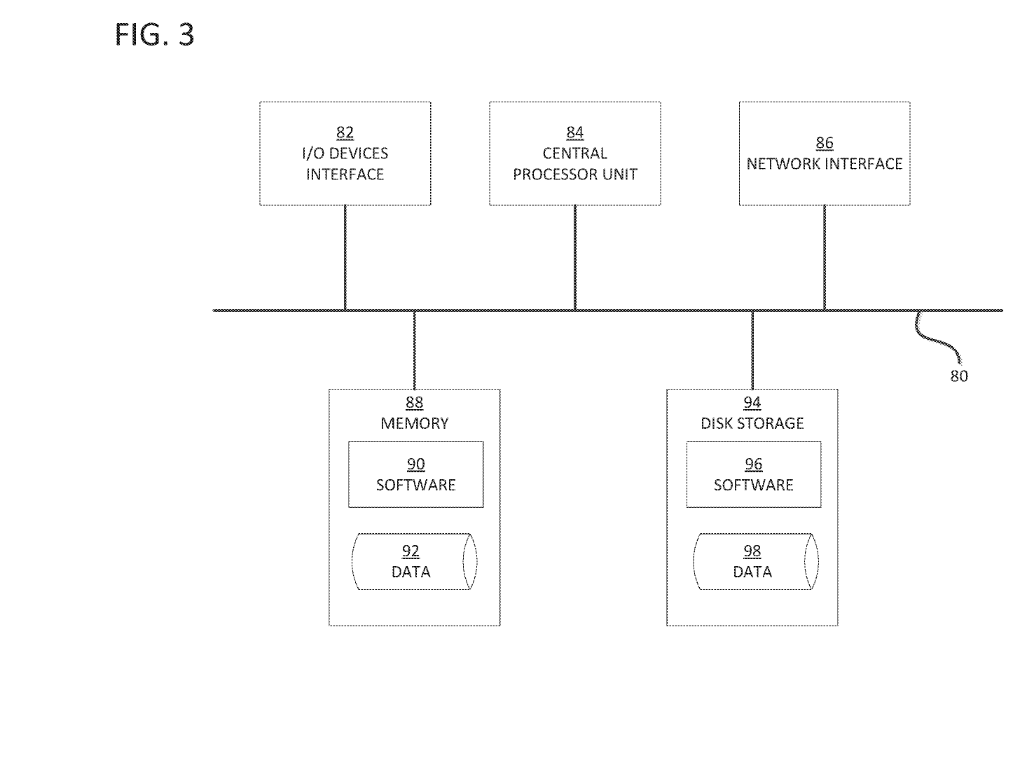

FIG. 3 is a diagram of one possible internal structure of a computer (e.g., computer 56) or server (e.g., server 52) in the system of FIG. 2. Each computer or server typically contains system bus 80, where a bus is a set of hardware lines used for data transfer among the components of a computer. Bus 80 is essentially a shared conduit that connects different elements of a computer system (e.g., processor, disk storage, memory, input/output ports, network ports, etc.) that enables the transfer of information between the elements. Attached to system bus 80 is I/O device interface 82 for connecting various input and output devices (e.g., displays, printers, speakers, microphones, etc.) to the computer. Alternatively, the I/O devices may be connected via one or more I/O processors attached to system bus 80. Network interface 86 allows the computer to connect to various other devices attached to a network (e.g., network 50 of FIG. 2). Memory 88 provides volatile storage for computer software instructions 90 and data 92 used to implement an embodiment of the present invention. Disk storage 94 provides non-volatile storage for computer software instructions 96 and data 98 used to implement an embodiment of the present invention. Central processor unit 84 is also attached to system bus 80 and provides for the execution of computer instructions.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Other systems, methods, and/or products according to the above embodiments will be or will become apparent to one of ordinary skill in the art upon review of the above description, the following drawings, and any further description. It is intended that all such additional systems, methods, and/or products be included within this description, be within the scope of the present invention, and be protected by the accompanying claims.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

That which is claimed:

1. A computer-implemented method for serving a webpage, the method comprising:
determining, by a computer, an actual load time of each of one or more webpages requested by a user;
comparing, by the computer, the actual load time for each webpage to a predetermined maximum desired load time specific to each webpage; and
if the actual load time for any of the one or more webpages is above the respective predetermined maximum desired load time, serving, by the computer, a lighter version of a subsequent webpage requested by the user.

2. The computer-implemented method of claim 1, wherein serving, by the computer, a lighter version of a subsequent webpage requested by the user comprises serving, by the computer, a lighter version of all subsequent webpages requested by the user during a current browsing session.

3. The computer-implemented method of claim 1, wherein the predetermined maximum desired load time specific to each webpage is based on data for a plurality of users of actual historical load times for each webpage correlated to completed purchases of goods or services during a same browsing session.

4. A computer program product for serving a webpage, the computer program product comprising a computer readable storage medium having program instructions embodied therewith, wherein the computer readable storage medium is not a transitory signal per se, the program instructions readable by a computer to cause the computer to perform a method comprising:
determining, by the computer, an actual load time of each of one or more webpages requested by a user;
comparing, by the computer, the actual load time for each webpage to a predetermined maximum desired load time specific to each webpage; and
if the actual load time for any of the one or more webpages is above the respective predetermined maximum desired load time, serving, by the computer, a lighter version of a subsequent webpage requested by the user.

5. The computer program product of claim 4, wherein serving, by the computer, a lighter version of a subsequent webpage requested by the user comprises serving, by the computer, a lighter version of all subsequent webpages requested by the user during a current browsing session.

6. The computer program product of claim 4, wherein the predetermined maximum desired load time specific to each webpage is based on data for a plurality of users of actual historical load times for each webpage correlated to completed purchases of goods or services during a same browsing session.
